(19) United States
(12) Patent Application Publication
(10) Pub. No.: US 2010/0126337 A1
(43) Pub. Date: May 27, 2010

(54) Vehicle Gunner's Protection Cuppola

(76) Inventor: Paul Carter, Fayetteville, NC (US)

Correspondence Address: NOVAK DRUCE + QUIGG LLP, 1300 EYE STREET NW, SUITE 1000 WEST TOWER, WASHINGTON, DC, 20005, US

(21) Appl. No.: 12/529,288

(22) PCT Filed: Mar. 7, 2008
(86) PCT No.: PCT/US08/03034

§ 371 Date: Jan. 7, 2010

Related U.S. Application Data
(60) Provisional application No. 60/893,611, filed on Mar. 7, 2007.

(51) Int. Cl. F41H 5/20; B23P 17/04; F41H 5/00

(52) U.S. Cl. 89/36.02; 29/428; 89/36.13

(57) ABSTRACT

An anti-ballistic guard is provided and includes a rigid frame that includes an outer portion of rigid ballistic material and an inner portion that includes a pliable outer shell or housing that encompasses an inner thermally resistant core which is housed or contained within an inner shell or housing and a inner ballistic core which is housed or contained within an inner shell or housing. Secured to exterior portions of the inner portion housing are pluralities of attachment points that facilitate the securement of the inner portion to the rigid frame. In one design, the inner portion outer cover comprises flame retardant, high performance fibers such as arimid, O-PAN, or a combination of these, and other high performance fibers.

### FIELD OF INVENTION

The present technology relates to modular multiple trauma threat protection systems, and in particular to a readily configured, field assembled and mounted, versatile vehicle-borne modular protective guard that is of a relatively lightweight construction and that may be configured to provide primary and/or supplemental ballistic, flame, and/or thermo-acoustical protection of an individual, a soldier, or a policeman partially or fully exposed to these threats in the performance of his duties.

### BACKGROUND OF THE INVENTION

The modern battlefield is more dangerous and violent than ever before. The changing nature of asymmetric warfare has moved a portion of the battlefield into an urban, setting, frequently occurring in transportation sector actions. The opponent's unconventional weapon of choice (I.E.D. or Improvised Explosive Device), and small arms fire whether in solitary action or vehicle-borne attacks, often causes physical wounds to body areas with inadequate ballistic protection, burns, and concussive injuries to the victim's head and soft body tissue, and frequently renders the vehicles inoperable. The utilization of vehicles in mounted patrols and the necessary transportation of personnel, material, supplies, and equipment provides a tempting target for these asymmetric warfare actions. These vehicle-borne soldiers and policemen frequently have inadequate protection from the ballistic, thermal, and thermo-acoustic threats generated by use of these weapons. Often the vehicles utilized have heavy rigid plates installed and arrayed in various configurations for ballistic protection. The currently available rigid plate ballistic protection systems are often awkward, self-limiting in design, and are too heavy to utilize in confined spaces making defensive or offensive actions difficult or often impossible for the occupants while providing little or no protection from these trauma threats.

Ballistic protection systems are widely used throughout the world in military, police, personnel protection, and security applications. The range and types of anti-ballistic protection systems are vast. For example, there is a wide range of heavy-duty anti-ballistic protection devices that are commonly employed on and around military vehicles. While effective in defeating many ballistic threats, these heavy-duty systems are cumbersome, difficult to assemble, and are labor-intensive to install. However, there has been little attention focused on the development of field installed modular protection from the ballistic, fire, and thermo-acoustic threats encountered. Attention to protection from the threat of fire is anticipated to focus on providing flame resistant apparel for selected crew served vehicles. There has been no offered feasible option for personnel protection from these threats and no protective equipment has yet been provided or fielded, which clearly demonstrates an unfulfilled need.

Therefore, there has been and continues to be a need for a versatile, modular, configurable for anticipated threat, rapidly assembled and field installed fire, thermo-acoustic, and anti-ballistic vehicle borne protection device for soldiers or policemen to use for effective operations and successful completion of a mission while in the confined space of a vehicle.

### SUMMARY OF THE INVENTION

The present technology relates to a rigid frame and related fasteners configured in appropriate curvature and fit for the desired protective zone, contoured and/or form-fitted segments of rigid or semi-rigid protective ballistic materials providing protection from bullets and ballistic threats, fitted thermal barrier (insulating) materials and segments of pliable ballistic materials constructed from modern high-performance fibers disposed within a shell of pliable materials which is enclosed by an outer shell or carrier of abrasion-, moisture-, and flame-resistant pliable materials providing protection from fire and thermo-acoustic threats. The outer shell or carrier is provided with a plurality of straps and/or fasteners for positioning and securing the pliable materials to the rigid frame containing the rigid or semi-rigid ballistic materials and thus providing rear and side skeletal and muscular protection from bullets and ballistic projectiles, flame, and thermo-acoustical threats. The present technology may be configured for specific anticipated threats. Other objects and advantages of the present invention will become apparent from a study of the following description and the accompanying drawings, which are merely illustrative of such invention.

### DESCRIPTION OF THE INVENTION

The present technology is configured to primarily provide rear and side ballistic, flame, and/or thermo-acoustic protection for the exposed or partially exposed vehicle occupant such as a gunner. The field assembled frame, ballistic protection segments, and fire and thermo-acoustic protection segments are designed to be installed to the roof mounted gun turret ring, providing mechanical stability and maneuverability for the gunner's operation of the mounted gun. The outer portion of the invention is comprised of contoured or fitted segments or plates constructed of a rigid or semi-rigid ballistic material. These segments are of relatively uniform physical size, shape and weight. These segments are inserted into receiving frame segments and are secured with fastening devices. These segments provide the primary ballistic protection. The interior portion of this invention is comprised of pliable thermally resistant and acoustical dampening materials fitted into segments matching or “backing” the rigid or semi-rigid ballistic material. The innermost portion of the invention is comprised of pliable ballistic material contained within an outer carrier constructed of a pliable, abrasion, moisture, and flame resistant quick drying material capable of accepting various Camouflage design patterns. This innermost portion of the invention provides protection for the gunner while engaged in tasks that subject the gunner to discomfort caused by contact with heat laden metals, impacts or pressure, and acoustical trauma. The end product is a modular, configurable, field assembled and installed device that is designed to defeat small arms and IED attacks, and to increase survivability after sustaining fire, thermo-acoustical, and ballistically undefeatable injuries.

The entire device can be logistically delivered with minimal space requirements, field configured and assembled, installed, and/or repaired. The device dimensions are proportionally modified to achieve installation on various vehicles and of various vehicle turret sizes. The device is of low weight, enabling a single person to assemble, install and/or repair the device with a minimum number of hand tools in a short period of time.

### BRIEF DESCRIPTION OF THE DRAWINGS

FIG. 1 is a plan view of the present invention configured for attachment to a ring turret gun mount assembly housing such as those utilized by HMMV and Stryker vehicles.

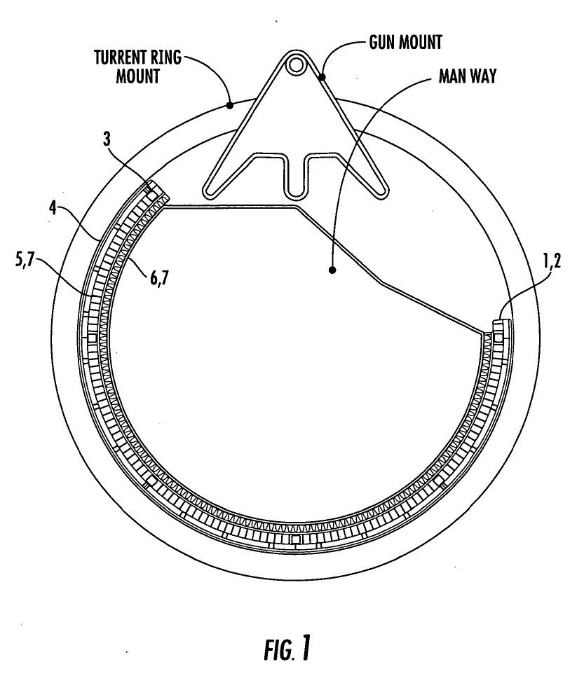

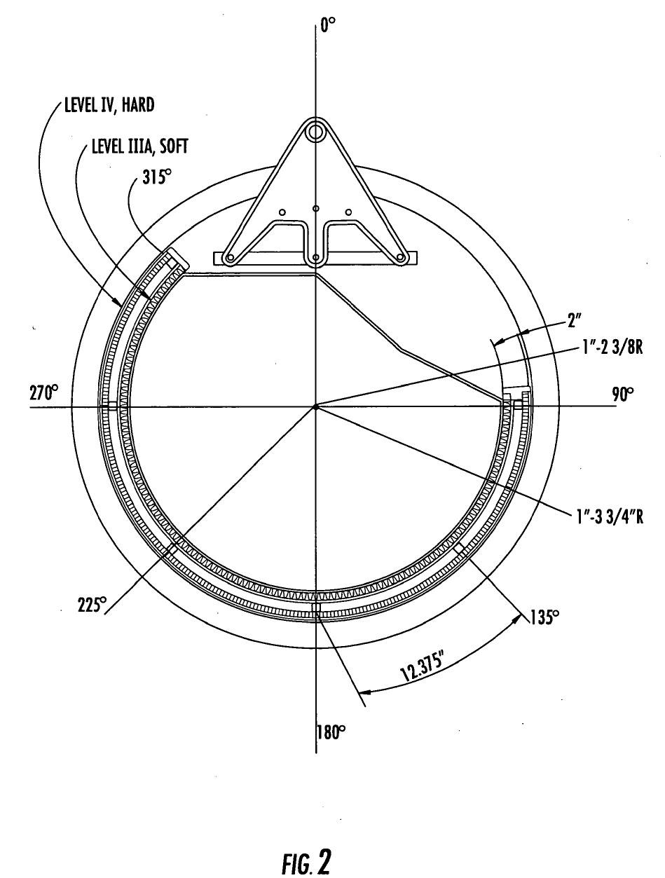

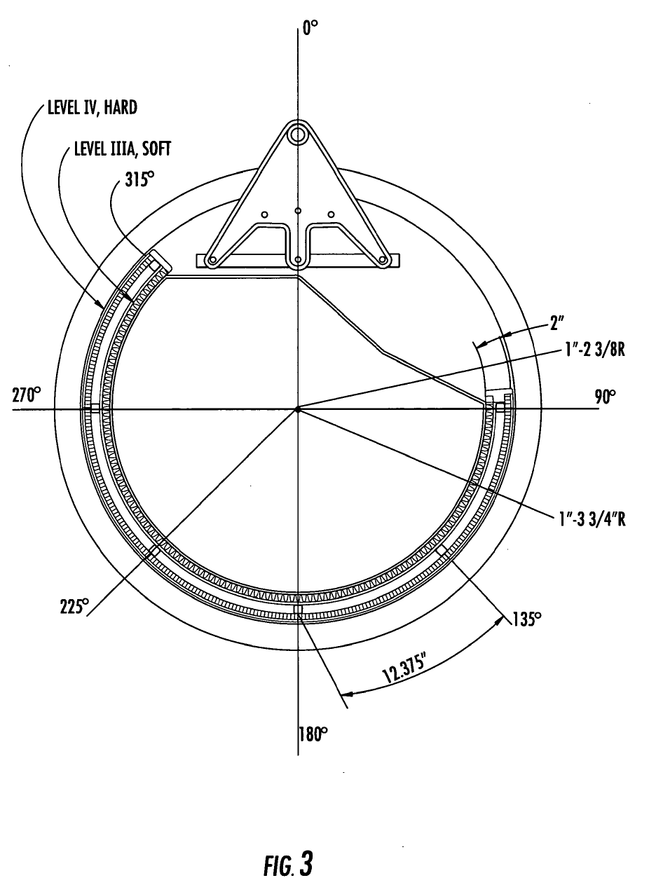

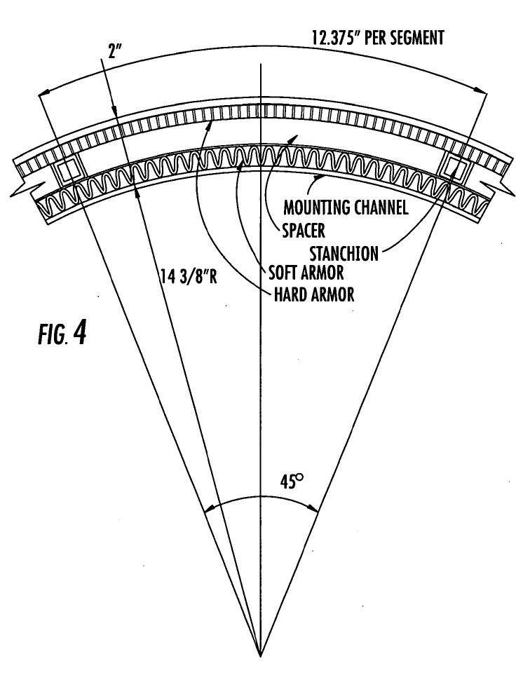

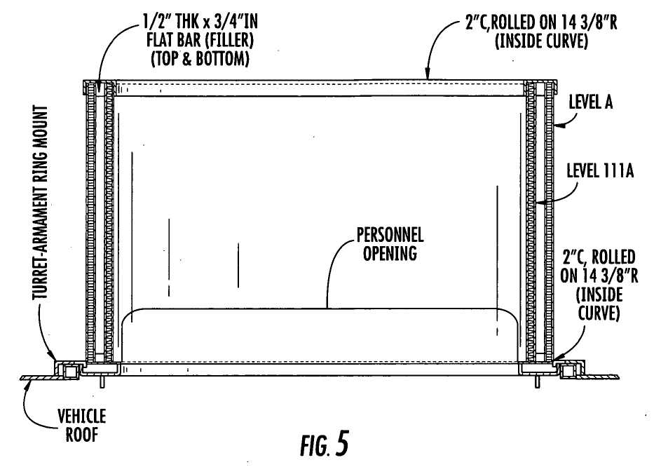

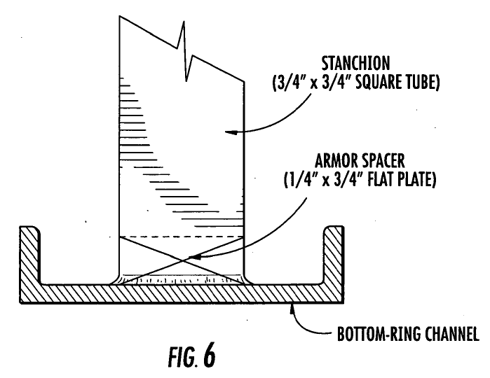

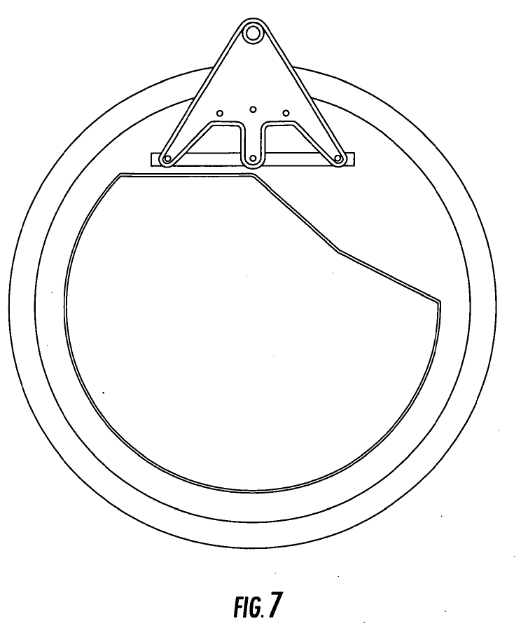

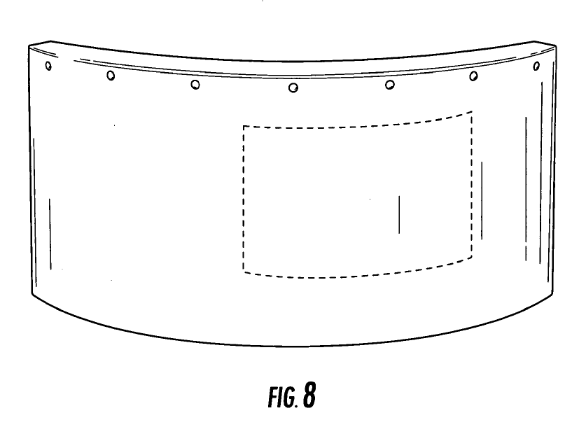

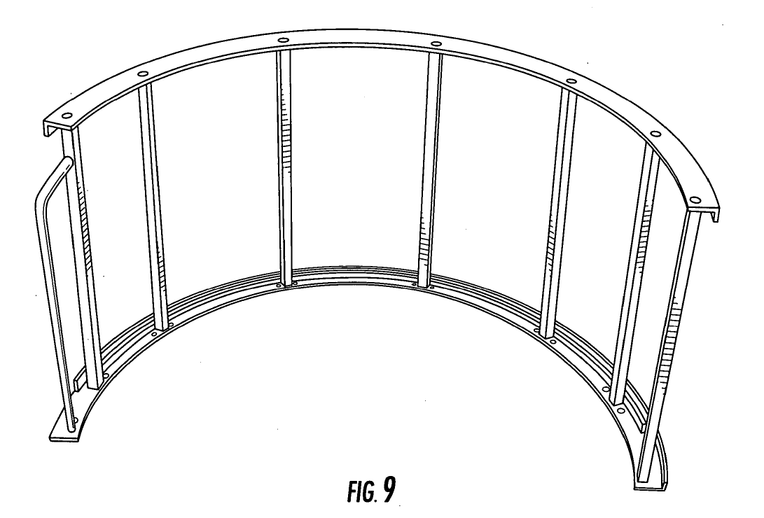

### DETAILED DESCRIPTION

With further reference to the drawing, the anti-ballistic guard is shown herein. Generally the anti-ballistic guard includes a rigid frame comprised of a lower member indicated by numeral 1, intermediate members indicated by numeral 3, and an upper member indicated by numeral 2. The anti-ballistic guard includes an outer portion of rigid ballistic material indicated by numeral 4, and an inner portion including an outer shell indicated by numeral 7, an inner core of thermally resistant material indicated by numeral 5, and an inner core of pliable ballistic material indicated by numeral 6.

The fielded HMMV non-tactical vehicle needs an estimated greater than or equal to stand alone NIJ Level IV armor for HMMV top gunner protection. This protection must provide 300 Degrees continuous circular protection to the sides and back of the gunner's position. The front is open to allow access to the crew served weapon.

The apparatus assembly is performed in the field with minimum tools and the apparatus is shipped to unit motor pool for assembly. Replacement or repair parts are installed in the field with minimum tools. The apparatus performs in ambient temperatures from 0 to 150° F. The ambient conditions will range from low humidity to 99% humidity at temperatures of 120° F. for extended periods of time. The apparatus is of low weight so as one person can assemble, install, and position as necessary for proper fit on vehicle. The maximum weight is estimated to be approximately 100 lbs plus the armor plates.

The apparatus comprise a metal frame of standard shapes, weights, and sizes with appropriate fasteners for frame member connections. In some embodiments, the armor is rigid, formed plate with appropriate curvature to provide the desired protective zones. In some embodiments, the armor material is spans an approximate 22.5° segment of the desired coverage zone. In some embodiments, the armor segments are uniform in size, shape and weight. In some embodiments, the meeting joints provide the same ballistic protective level as the solid segments. In some embodiments, the armor segments are enclosed in a flame resistant fabric covering to provide ATPV protection in excess of 40 Calories per square centimeter of surface area. In some embodiments, the interior of the assembly is curtained with a modified Ballistic Fortress ^{TM} ballistic blanket or other approved soft hanging armor, to provide supplemental ballistic protection, thermal insulation, and as padding from the metal frame members. The HMMV top is unarmored, constructed of relatively thin metal or canvas and will provide limited ballistic protection for the vehicle occupants. As a supplemental protection means, a segmented replacement top in accordance with the present technology is provided. This replacement top includes strengthening the turret ring and hatch frame, or replacing the bearings in the sliding mechanism with a device such as a UHMW polyethylene semi circular ring. The plates can be arranged in a tight cylinder or can be arrayed in an open top dome, as to deflect an overpressure or acoustical wave.

What is claimed is:

1. A rigid frame, anti-ballistic guard, comprising:
a rigid frame having an upper member, a lower member, and a plurality of intermediate members, and which forms generally closed areas;
an outer rigid portion being relatively thin compared to the length and width of the outer portion;
an inner portion having a pliable outer housing having an outer surface and an inner surface, and which forms a generally closed interior area, the outer housing being relatively thin compared to the length and width of the outer housing;
an inner housing disposed in the interior area of the outer housing and generally surrounded by the outer housing;
a thermally insulating core contained within the inner housing and comprising thermally insulating material such as arimid fibers, O-PAN fibers, fiberglass fibers, or silicone, and carbon based fibers;
an inner housing disposed in the interior area of the outer housing and generally surrounded by the outer housing;
a ballistic core contained within the inner housing and comprising high performance fibers such as high molecular weight polyethylene, aramid fibers, or a combination of these and other high performance fibers;
the outer housing including a perimeter and including a plurality of attachment points around the perimeter of the outer housing;

2. The anti-ballistic guard of claim 1 wherein the rigid frame members are constructed of materials taken from the ferrous alloy groups including carbon steel, stainless steel, and other alloys or from rigid material groups;

3. The anti-ballistic guard of claim 1 wherein the inner portion outer housing is constructed of material taken from the group including fabric, vinyl, leather, and pliable synthetic materials.

4. The anti-ballistic guard of claim 1 wherein the inner portion outer housing includes two sides with one side separated into a plurality of sections and wherein there is provided a plurality of access openings that permits access to the inner housing and wherein the access openings at least partially delineates the two sections.

5. The anti-ballistic guard of claim 1 wherein the inner portion outer housing includes two opposed sides, and wherein the straps or webbing are secured to the outer portion of one side.

6. The anti-ballistic guard of claim 1 wherein the rigid frame lower member is secured to a vehicle or other structure;

7. The anti-ballistic guard of claim 1 wherein the rigid outer portion is contained within generally closed areas defined by the rigid frame lower member, the rigid frame intermediate members, and the rigid frame upper member;

8. The anti-ballistic guard of claim 1 wherein the rigid frame intermediate members are secured to the rigid frame lower member;

9. The anti-ballistic guard of claim 1 wherein the rigid frame intermediate members are secured to the rigid frame upper member;

10. The anti-ballistic guard of claim 1 wherein the inner portion outer cover is secured to the rigid frame intermediate members and the rigid frame upper member;

11. The anti-ballistic guard of claim 1 wherein at least one portion of the outer rigid portion is constructed of rigid ballistic material and is secured within the area generally contained within the rigid frame upper member and the rigid frame lower member;

12. The anti-ballistic guard of claim 1 wherein the inner portion outer housing is relatively thin compared to the length and width of the anti-ballistic guard;

13. The anti-ballistic guard of claim 1 wherein the inner portion outer housing includes two opposed sides and a perimeter extending around the outer housing, and a series of attachment points around the perimeter of both sides of the perimeter;

14. The anti-ballistic guard of claim 1 wherein the thermally insulating core comprises thermally efficient materials such as arimid, O-PAN, fiberglass, or silicon, or carbon based materials;

15. The anti-ballistic guard of claim 1 wherein the pliable ballistic core is comprised of high performance fibers such as ultra-high molecular weight polyethylene, arimid fibers, or a combination of these, and other high performance fibers;

16. A method of manufacturing an anti-ballistic guard, comprising:
forming a rigid frame lower member, intermediate members, and a rigid frame upper member;
forming the rigid frame such that the lower member, intermediate members, and the upper member generally form closed areas;
forming rigid ballistic materials such that the ballistic materials are inserted and secured within the rigid frame enclosed areas;
forming the pliable inner portion outer housing such that the inner portion is thin compared to the length and width of the inner portion;
inserting an inner housing into the interior of the inner portion outer housing where the inner housing is surrounded and generally enclosed by the outer housing;
inserting a pliable ballistic core into the inner housing such that the ballistic core is surrounded and enclosed by both the inner housing and the outer housing;

17. The method of claim 16 including securing the anti-ballistic guard to a vehicle or other structure;
